(19) United States
(12) Patent Application Publication
(10) Pub. No.: US 2007/0260908 A1
(43) Pub. Date: Nov. 8, 2007

(54) Method and System for Transaction Recovery Time Estimation

(75) Inventors: Ian James Mitchell, Hants (GB); Andrew Wright, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/676,327

(22) Filed: Feb. 19, 2007

(30) Foreign Application Priority Data
Mar. 14, 2006 (GB) 0605064.5

(51) Int. Cl. G06F 11/00

(52) U.S. Cl. 714/2

(57) ABSTRACT

To generate a recovery time estimate in a transaction environment, a system includes a recovery manager, a recovery file containing recovery data, a store of historical restart data, and a recovery time estimation component. The recovery manager includes a component which is operable to measure the volume of active data on the recovery file, and to generate a recovery time estimate based on the measured volume and the historical restart data. This recovery time estimate can then be used as a characteristic of the system's keypointing policy to provide a more flexible and efficient keypointing procedure.

### FIELD OF THE INVENTION

The present invention relates to the field of the data processing and in particular to a system and method for generating a recovery time estimate in a transaction environment.

### BACKGROUND OF THE INVENTION

A transaction in the business sense can be viewed as an activity between two or more parties that must be completed in its entirety with a mutually agreed-upon outcome. It usually involves operations on some shared resources and results in overall change of state affecting some or all of those resources. When an activity or a transaction has been started and the mutually agreed outcome cannot be achieved, all parties involved in a transaction should revert to the state they were in before its initiation. In other words, all operations should be undone as if they had never taken place.

There are many examples of business transactions. A common one involves transfer of money between bank accounts. In this scenario, a business transaction would be two-step process involving subtraction (debit) from one account and addition (credit) to another account. Both operations are part of the same transaction and both must succeed in order to complete the transaction. If one or these operations fails, the account balances must be restored to their original states.

In the context of business software, we can express the above more precisely. A transaction is the execution of a set of related operations that must be completed together. This property of a transaction is referred to as ‘atomicity’ and this set of operations is often referred to as a ‘Unit-Of-Work’ or ‘UOW’. A transaction is said to ‘commit’ when it completes successfully. Otherwise it is said to ‘roll back’. In the example above, the money transfer operation is a UOW composed of debiting one account and crediting another.

Transactions can be encountered and discussed at many different levels, from high-level business transactions, such as a travel reservation request or a money transfer operation, to low-level technical transactions, such as a simple database update operation. Quite often, different sets of processing requirements are associated with these transaction levels.

To the simplest case, a transaction will access objects located at a single server. Such a transaction is referred to as a ‘local transaction’. More often, a transaction will access objects which are located in several different computers. Such a transaction is referred to as sa ‘distributed transaction’.

When a distributed transaction ends, the atomicity property of transactions requires that either all of the computers involved commit the transaction or all of them abort the transaction. To achieve this one of the computers takes on the role of coordinator to ensure the same outcome at all the parties to the transaction, using a ‘coordination protocol’ that is commonly understood and followed by all the parties involved. The two-phase commit protocol has been widely adopted as the protocol of choice in the distributed transaction management environment. This protocol guarantees that the work is either successfully completed by all its participants or not performed at all, with any data modifications being either committed together or rolled back together.

Another property of a transaction is its durability. This means that once a user has been notified of success, a transaction's outcome must persist, and not be undone, even when there is a system failure. A recovery manager is used to ensure that a server's objects are durable and that the effects of transactions are atomic even when the server crashes. A server's recovery manager saves objects in a recovery file in permanent storage or committed transactions and restores the server's objects after a crash. Typically, the recovery file comprises a log containing the history of all transactions performed by a server. All transactions are written into the log before the transaction is deemed to be committed. In the event of a system failure, the log an be played back to return the system to its state right before the failure.

Transaction logging is an integral part of recovering from system and media failures. Using transaction logging provides insurance against system failure, but creating regular backups is essential so that you can recover data after a failure. Examples of systems which carry out such logging include transaction systems such as IBM®'s CICS® Transaction Server or WebSphere® Application Server, as well as database systems such as DB2® or IMS™ (IBM, CICS, WebSphere, DB2 and IMS are trade marks of International Business Machines Corporation). When such a system suffers a failure that requires that it restart, the recovery file is read to recover the state of the system prior to the failure. The transaction logs are used to check for and undo transactions that were not properly completed before failure.

The recovery file typically recovers the information in the order that the activity occurs Without some management, this would consume an ever increasing amount of resource. So it must be reorganized now and then so as to reduce its size and, therefore, speed p the process of recovery, by the recovery manager carrying out a process called ‘keypointing’, sometimes also referred to as ‘checkpointing’. Keypointing comprise writing current committed values of a server's objects to a new recovery file, together with transaction status entries and intentions lists for transactions that have not been fully resolved. An intentions list for all transaction contains a list of the references and the values of all the objects that are altered by that transaction, as well as information related to the two-phase commit protocol. The purpose of making keypoints, i.e. storing information through a keypointing procedure, is to reduce the number of transactions to b dealt with during recovery and reduce the file size of the recovery file by discarding the recovery information for irrevocably committed transactions. Appropriate keypointing will bound the volume of data that must be read during recovery.

Keypointing can be done immediately after recovery but before any new transactions are started. However, recovery may not occur sufficiently often, and needs to be triggered periodically. In some systems, keypointing is carried out each time a threshold number of log writes have taken place. The optimum frequency at which the keypointing process should be conducted is often difficult to determine. The more often the process is done, the smaller the log file size remains. However, the keypointing process itself has an increased CPU usage overhead, which is an incentive to do this process infrequently.

One factor which affects recovery time is the time taken in reading the recovery file itself. This can be a significant proportion of the restart processing, and is only loosely related to the number of log blocks written between keypoints. The present invention is intended to aid in the determination of when keypointing should take place in order to optimize the system and improve the efficiency of reorganization of the recovery file.

### SUMMARY

A first aspect of the present invention provides a system for generating a recovery time estimate in a transaction environment. The system comprises a recovery manager, a recovery file containing current recovery data, a store of historical restart data, and a recovery time estimation component. The recovery manager is operable to monitor the current volume of the recovery file, and the recovery time estimation component is operable to generate a recovery time estimate based on the current recovery file volume and the historical restart data.

A second aspect of the present invention provides a method of generating a recovery time estimate in a transaction system comprising a recovery file containing recovery data. The method comprises storing historical restart data; monitoring the current volume of the recovery file; and generating an estimate of recovery time based on the current recovery file volume and the historical restart data.

Other aspects of the invention are defined in the appended claims, to which reference should not be made.

The system tracks the live log data volume of the active system and compares that data to the recovery rates from past restarts. Unless the environment (hardware, other processes sharing the same operating system, etc, etc) at the time the next recover is performed is radically different, then the comparison with past performance will be a valid indication of the future. Thus, a combination of past history and current state is used to provide an indication of likely restart time should the system fail. This allows a more direct monitoring of potential recovery time and policy definition associated with this characteristic.

The system can have a keypointing policy which outlines the various thresholds and parameters to be taken into account in order to determine when to carry out a keypointing process. When an estimate of the recovery time has been generated, the system may issue a message to allow the estimated time to be compared to this policy, and a determination made as to whether to carry out the keypointing process. This determination could be made either by an administrator or actioned by an automated operator. Additionally, state information may be recorded to enable a programmatical response to the determination.

The present invention thus improves the manageability of the system for recovery.

### BRIEF DESCRIPTION OF THE DRAWINGS

Preferred embodiments of the present invention will now be described by way of example only, with reference to the accompanying drawings in which:

FIG. 1 shows a system for generating a recovery time estimate in accordance with any embodiment of the invention;

FIG. 2 shows a CICS transaction system in accordance with a preferred embodiment;

FIG. 3 shows details of an example log stream;

FIG. 4 shows a flowchart of the method of estimating recovery time according to a preferred embodiment of the invention; and

FIG. 5 shows active log data volume tracking and keypoints according to a preferred embodiment of the invention.

### DETAILED DESCRIPTION

Preferred embodiments of the invention will be described with regard to distributed transactions using the two-phase commit protocol. In order to ensure atomicity of the distributed transaction in which an application changes data in multiple servers/resource managers, a syncpoint manager is used to ensure that all of those changes are accomplished through a single commit request. Applications usually access resources via resource managers.

The two-phase commit process is as follows:

First phase: all participants are asked by the syncpoint manager to prepare to commit. If a given resource manager an commit its work, it replies affirmatively, agreeing to accept the outcome decided by the syncpoint manger. It can no longer unilaterally abort the transaction. Such resource manager is said to be in the ready-to-commit or prepared state. If a resource manager cannot commit, it responds negatively and rolls back its work.

Second phase: the syncpoint manger asks all resource managers to commit if all are in the ready-to-commit (prepared) state. Otherwise it requests to roll back. All resource managers commit or roll back as directed and return status to the syncpoint manager. If the transaction is successful, all the changes are committed. If any piece of the transaction is not successful, then all changes are baked out. When all the changes are committed, the syncpoint manager updates a system log with a commit record for the transaction.

The system of the present invention comprises a server 8, which has a recovery manager 10, a recovery file 12, a recovery time estimation component 14 and a store of previous restart statistics 16 as shown in FIG. 1. The recovery time estimation component uses the live volume of the recovery file and uses recovery rates from past restarts stored in the statistics file 16 to estimate the likely recovery time if the system were to fail.

The recovery time estimate can be used to optimize the reorganization of the recovery file, by indicating appropriate points at which a keypointing operation should be carried out.

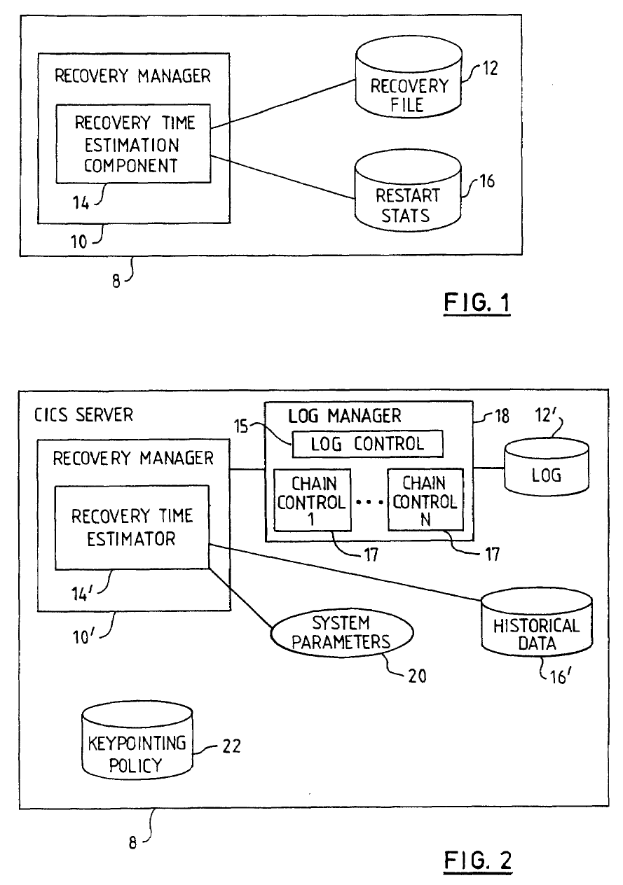

One preferred embodiment of the invention is implemented in IBM's CICS transaction environment and will be described in more detail with reference to FIG. 2. CICS Transaction Serve has been developed to exploit the parallel sysplex environment. This is a combination of software and hardware facilities designed to provide high speed sharing of data and communications between separate z/OS® regions bound together through the use of coupling methods (z/OS is a registered trade mark of International Business Machines Corporation).

In CICS, the recovery file used to support system recovery is called the CICS System Log 12′. This is used to store log records required to provide dynamic transaction backout of a failing Unit-Of-Work (UOW)—for example, when a task abends having written to a recoverably Virtual Storage Access Method (VSAM) file. In addition, the CICS System Log is used for recovering an entire CICS system to a committed state when performing an emergency restart.

According to the preferred embodiment, the CICS Transaction Server 8 also comprises a Recovery Manager 10′, a Log Manager 18, a recovery time estimation component 14′, system parameters 20, a keypointing policy 22 and historical restart data 16′.

The Log Manager 18 manages log data in entities known in log streams. A log stream is a series of blocks of data. Each log stream is identified by its own (unique) log stream identifier, known as the log stream name. The CICS Log Manager implements various log streams for its own use, and other are available for user purposes. CICS Log Manager is responsible for handling the movement and manipulation of UOW log data on CICS System Log streams. The Log Manager comprises a Log Control 15 as well as a plurality of Chain Controls 17, which monitor write requests to the log stream and maintains a count of bytes written to the log, as will be explained in more detail later.

The CICS Recovery Manager 10′ coordinates UOW and CICS system recovery. The Recovery Manager invokes the Log Manager to store and retrieve log data for commit and backout purposes.

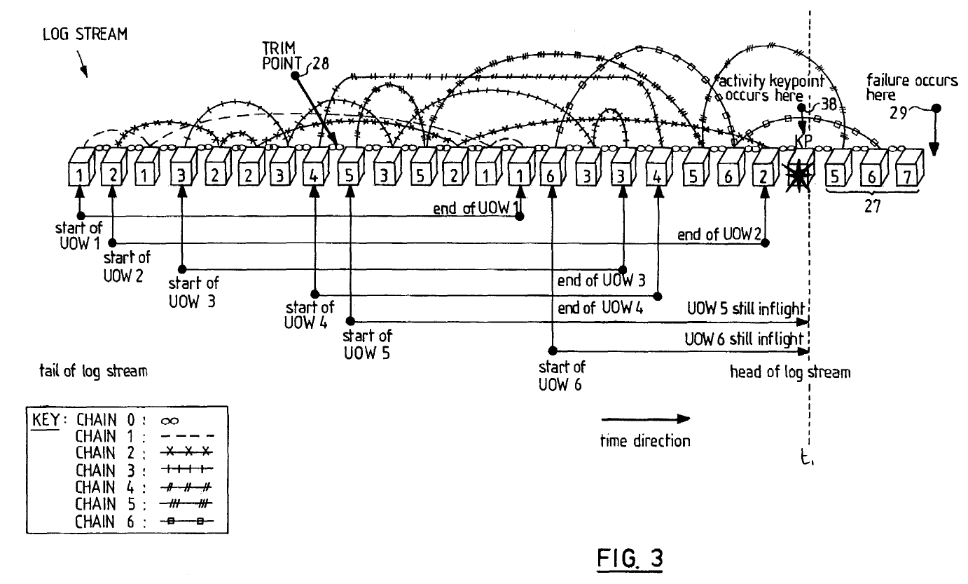

The CICS System Log records “before-image” of changes to resources managed under CICS. Each log record is associated with a particular UOW and has an ID number called the ‘blockid’, which orders the log records in a sequential manner. Additionally, a log record may have a pointer to the blockid of the previous log record associated with the same UOW. Thus the log records are said to be linked together in ‘chains’ associated with particular UOWs, as well as in chronological order, as shown in FIG. 3. In this example of a log stream, a time t₁ UOWs 1, 2, 3, 4 5 and 6 have each written to the log. Chain 0 represents a sequential chain from each log record back to the preceding record. Chains 1 to 6 link together log records associated with UOWs 1 to 6 respectively.

Tasks within CICS can issue syncpoints to mark their work as irrevocably committed. Part of syncpoint processing involves the logical deletion of the log data for the task's UOW. This data is still held on the System Log however, and needs to be deleted by a call to the Log Manager, which CICS issues periodically as part of activity keypoint processing.

Typically, CICS attaches a keypoint task every now and then, when a threshold number of log writes have taken place. This number is specified by the CICS ‘AKPFREQ’ system parameter. If this number is “high”, CICS will schedule keypoints less often, and so keypointing is less invasive in terms of CPU use, etc. However, the downside is that more data has to be retained on the CICS System Log between keypoints, since it is the action of taking a keypoint that also allows CICS to tell the Log Manager to delete unwanted log data Conversely, a “low” AKPFREQ will better manage the log data by deleting unwanted log records more often, but at the expense of extra CPU usage in running keypoint tasks.

At the time of an activity keypoint, the CICS Log Manager will determine the position of the oldest log data still required for any UOW of interest to CICS. The CICS System Log data created before this pint can then be deleted. This process is known as trimming the tail of the System Log.

Consider a keypoint operation taking place at the point 38 shown in FIG. 3. CICS will determine the oldest point on the log stream of any log chain associated with a UOW which is still in-flight. This will be the chain instance containing the lowest blockid value. At keypoint time, each chain instance will be examined and the oldest history point (lowest blockid) used to determine the trim point 28. The two chains of interest at keypoint time are for UOWs 5 and 6 (as the other UOWs have all ended by the time of the keypoint). UOW 5 has the lowest blockid (oldest history point), so CICS will call the Log Manager to delete log stream blocks up to the blockid of the log record at the start of UOW 5, which is called the trim point 28.

When CICS is recovered, the Recovery Manager reads back along the System Log to the last complete set of keypoint data KP. This involves a backwards sequential read, from the head of the log, through the post-keypoint data, back to the start of the last keypoint. From the log records encountered during the backwards sequential read and the data logged within the keypoint, the UOWs of interest (i.e. those that were in-flight when CICS failed) are determined. The restart can then be optimized by reading back along the chains of log records for just these UOWs. This is sometimes called “turbo mode” within CICS recovery.

Consider a failure happening at the point 29 shown in FIG. 3, when UOW 7 has just started and is in-flight, along with UOWs 5 and 6. CICS Log Manager will first carry out a backwards sequential scan, from the head 29 of the log stream back through the post-keypoint data 27 up to the previous complete keypoint KP. From the log records encountered during this scan, and the keypoint data, Log Manager determines the UOWs of interest (i.e. those that were in-flight when CICS failed), in this example UOWs 5, 6 and 7. The restart process can then be limited to reading back along the chains of log records for just these UOWs, i.e. chains 5, 6 and 7. This avoids having to rad back sequentially along the log to retrieve these UOWs log records, which would also encounter a lot of log data for other transactions which are not relevant to the restart, i.e. UOWs 1, 2, 3 and 4. By reading back along the chain of records for just each UOW of interest, rather than for all log records, the time spent performing the restart is minimized.

The restart process is configured to record statistics about the recovery log scan-rates of processing in terms of log volume processed per sec (could be bytes, records or blocks, or perhaps all three) in the historical data file 16′. This data could be stored as a rolling average across a number of restarts, or may comprise just data for the last restart. The restart process may also issue a message for display to the system programmer/operator at the end of the recovery to report the recovery file read-rate that was achieved.

So, an estimate of the recovery time according to this embodiment is preferably based both on the log data volume per UOW, as well as CICS log data volume in total. This requires a ‘per UOW’ log volume measure, which is recorded as a count value 19 by the chain controls as will be explained below.

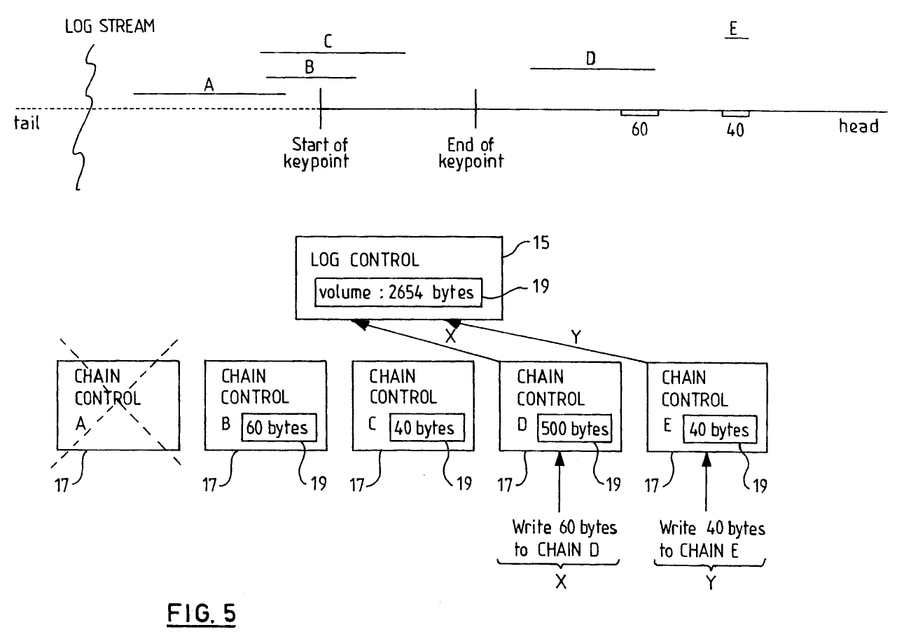

The method of tracking log data volume will now be described with reference to FIG. 5.

The log manager tracks the bytes, records and/or blocks that have been written to the log since the last keypoint, and which would need to be read during a restart, to determine the current volume of active log data. Write requests to the log are monitored by the chain controls 17, and the log control 15. Each chain controller counts the volume (typically, the number of bytes) of data written to its associated UOW chain. The log controller 16 counts the volume of all data written to the log.

Though shown in FIG. 3 as a single log record for the sake of simplicity, the CICS keypointing process actually comprises a separate UOW, and other UOW log writes may occur between the start and end of the keypoint process, as shown in FIG. 5. At the start of a keypoint, the sum of the volume of the active chains is recorded and used as the starting value of a new log control count, which will be stored and updated in addition to the active log control count. When the log is trimmed at the end of the keypoint, the new low control count value will become the active log controller volume count and will be incremented as new data is logged.

Looking at the example shown in FIG. 5, consider a write request ‘X’ which requires that 60 bytes of data be written to chain D. On interception of this request, the controller 17 for chain D will update its volume count by 60, before the request is passed on to the log control 15. The log control maintains a volume count of the total log, which in the example shown is 2654 bytes. This comprises the volume of chains active at the start of the keypoint (note, that not all chains are shown), plus the volume counts of any post-keypoint data, such as the volume counts of chains D and E. The total log control value is updated each time there is a write to the log, e.g. ‘X’ or ‘Y’.

The chain control count for a UOW which committed before the last complete keypoint, such as chain A, is no longer required, and can be deleted.

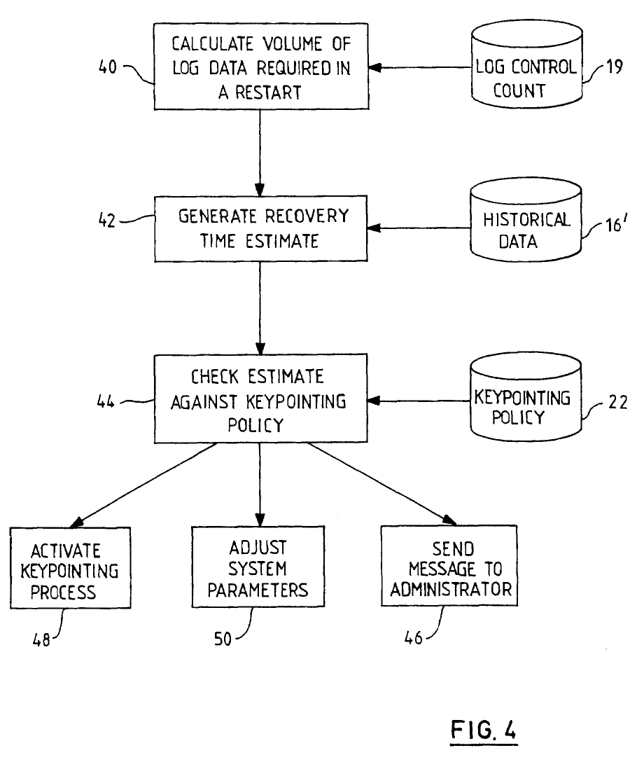

The volume of active data written to the log is equivalent to that which will be read during any recovery, so a count of the number of bytes written is made. The method of estimating a recovery time according to the preferred embodiment will now be described with reference to FIG. 4. The estimation component reads the volume count maintained by the log controller as well as the volume count of any active chains stored by their chain controllers and calculates 40 the volume of log data which would need to be read in a restart. The estimation component then uses this calculated volume and the historical log processing rates stored in the historical data file 16′ to generate 42 a predication of the time required to scan the log should the system fail.

The server stores a keypointing policy 22 which outlines the various thresholds and parameters to be taken into account in order to determine when to carry out a keypointing process. For example, the policy might comprise the objective that recovery should take no more than 30 seconds. The keypointing policy also defines actions to be taken in dependence on the value of the recovery time estimate generated by the estimation component.

When an estimate of the recovery time has been generated by the recovery time estimation component 14′, the system may issue a message to allow the estimated time to be compared 44 to this policy, and a determination made as to whether to carry out 48 the keypointing process. This determination could be made by an administrator after the issuance 46 of a message indicating the estimated recovery time. Alternatively, this determination could be actioned automatically, and additional state information may be recorded to enable a programmatical response to the determination.

The provision of a recovery time estimation component allows the system to include in its keypointing policy a preferred maximum value for the estimated recovery time. The system can periodically check 44 the predication against the keypointing policy. In addition to the options of sending 46 a message to a user or activating 48 the keypointing process following this periodic check, the system may adjust 50 the system configuration parameters (such as keypoint interval) in order to achieve the keypointing policy.

In CICS all of the bytes, re cords and/or blocks that have been written to the log since the last keypoint will be read during recovery processing. Thus the worst time for the system to fail would be immediately before a keypoint. Thus as the time for the next keypoint draws nearer, the benefit of evaluating the estimated time to read the data that has been logged and comparing it to the policy increases. Thus the system may be configured to generate a recovery time estimate more frequency as the next keypoint approaches.

The present invention thus enables a system to generate an estimate of recovery times and use this to provide a more flexible keypointing process and efficient recovery file reorganization.

Insofar as embodiments of he invention described are implement able, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods in envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable from, for example in solid-state memory, magnetic memory such as disc or tape, optically or magneto-optically readable memory such as compact disk (CD) or Digital Versatile Disk (DVD) etc, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has ben described in relation to the preceding example embodiments, the invention is not limited thereto and that there are many possible variations and modifications which fall within the scope of the invention.

The scope of the present disclosure includes any novel feature or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

For the avoidance of doubt, the term “comprising”, as used herein throughout the description and claims is not to be construed as meaning “consisting only of”.

What is claimed is:

1. A system for generating a recovery time estimate in a transaction environment, the system comprising:
a recovery file containing recovery data;
a recovery manager operable to measure the volume of active data in the recovery file;
a store of historical restart data; and
a recovery time estimation component operable to generate a recovery time estimate based on the measured recovery file volume and the historical restart data.

2. A system according to claim 1, wherein the recovery file comprises a log, the system further comprising a log manager which manages log data in at least one log stream.

3. A system according to claim 2, wherein the log manager comprises a log controller which maintains a count value indicative of the volume of active data in the recovery file.

4. A system according to claim 3, wherein the log controller is operable to intercept writes to the recovery file and update its count value accordingly.

5. A system according to claim 4, wherein each log record is associated with a particular transaction and the log manager further comprises a chain controller, associated with each transaction, which is operable to maintain a count value indicative of the volume of active data on the log which is associated with that transaction.

6. A system according to claim 5, wherein the estimation component is operable to read the count value maintained by the log controller, and the count values of any chain controllers associated with active transactions, to calculate the active volume of data on the log.

7. A system according to claim 1, further comprising a keypointing policy which defines a set of actions to be taken in dependence upon the value of a recovery time estimate.

8. A system according to claim 7, further comprising means for comparing the generated recovery time estimate to the keypointing policy.

9. A system according to claim 8, operable to activate a keypointing process in dependence on the result of the comparison.

10. A system according to claim 1, further comprising means for sending data identifying the generated recovery time estimate to a user.

11. A system according to claim 10, further comprising means for adjusting at least one system parameter in dependence on the result of the comparison.

12. A system according to claim 11, wherein the adjusting means is operable to adjust the keypoint interval in dependence on the estimated recovery time.

13. A system according to claim 1, wherein the estimation component is operable periodically to generate a recovery time estimate.

14. A method of generating a recovery time estimate in a transaction system comprising a recovery file containing recovery data, the method comprising:
storing historical restart data;
measuring the volume of active data on the recovery file; and
generating an estimate of recovery time based on the measured volume of active data and the historical restart data.

15. A method according to claim 14, comprising providing a log manager for managing log data in at least one log stream in the recovery file.

16. A method according to claim 15, further comprising the log manager maintaining a count value indicative of the volume of active data in the recovery.

17. A method according to claim 16, further comprising the log manager intercepting writes to the recovery file and updating its count value accordingly.

18. A method according to claim 17, wherein each log record in the recovery file is associated with a particular transaction and the log manager further comprises a chain controller, associated with each transaction, which maintains a count value indicative of the volume of active data on the log which is associated with that transaction.

19. A method according to claim 18, further comprising the estimation component calculating the active volume of data in the recovery file by reading the count value maintained by the log manager, and the count values of any chain controllers associated with active transactions.

20. A computer program product for generating a recovery time estimate in a transaction system having a recovery file containing recovery data, the computer program product comprising a computer usable medium having computer usable program code tangibly embodied therewith, the computer usable medium comprising:
computer usable program code configured to store historical restart data;
computer usable program code configured to measure the volume of active data on the recovery file; and
computer usable program code configured to generate an estimate of recovery time based on the measured volume of active data and the historical restart data.
